(19) United States
(12) Patent Application Publication
(10) Pub. No.: US 2024/0365811 A1
(43) Pub. Date: Nov. 7, 2024

(54) DE-FLAVORED FAVA BEAN PROTEIN CONCENTRATES AND METHODS OF MANUFACTURE

(71) Applicant: CORN PRODUCTS DEVELOPMENT, INC., WESTCHESTER, IL (US)

(72) Inventors: Sharon BENDER, Bridgewater, NJ (US); Oyelayo JEGEDE, Bridgewater, NJ (US); Xavier O'CONNELL, Bridgewater, NJ (US); Roxanna SHARIFF, Bridgewater, NJ (US); Delong SONG, Bridgewater, NJ (US); Meng XUE, Bridgewater, NJ (US)

(21) Appl. No.: 18/683,890

(22) PCT Filed: Aug. 16, 2022
(86) PCT No.: PCT/US2022/040456

§ 371 Date: Feb. 15, 2024

Related U.S. Application Data
(60) Provisional application No. 63/235,229, filed on Aug. 20, 2021.

(51) Int. Cl. A23J 3/14; A21D 2/26; A21D 13/045; A21D 13/066; A23L 5/20

(52) U.S. Cl. CPC A23J 3/14; A21D 2/266; A21D 13/045; A21D 13/066; A23L 5/21

(57) ABSTRACT

This specification discloses methods for removing unwanted flavors from legume protein concentrates, which are powdered legume compositions that have been classified to increase the protein compared to the protein content of the base legume. In at least some embodiments the methods are used to make de-flavored fava bean protein concentrates. Advantageously, the methods are selected to minimize damage to the de-flavored legume protein concentrates by reference to percent change of denaturation enthalpy compared an untreated legume protein concentrate.

The technology disclosed in this specification pertains to legume protein concentrates that have been processed to remove unwanted flavors and more specifically to fava bean protein concentrates.

Legumes, and more specifically fava beans are high in protein, gluten free making, and are commonly ground to form a powdered compositions, which in this specification like flours and protein concentrates. This specification focuses on legume protein concentrates and more specifically to fava bean protein concentrates. Within this specification, legume protein concentrates refer to powdered compositions having elevated legume protein relative to the protein content naturally in the legume. Within the context of legume protein products, legume protein concentrates have protein content from about 50% to about 70%. Legume protein products having less protein content may be called legume flours. Legume protein products having more than about 70% protein may be called protein isolates. Relative to legume flours, legume protein concentrates may be preferred for their higher protein content. Relative legume protein isolates, legume protein concentrates may be preferred because they are not as harshly processed and so have less damaged starch and protein.

This specification discloses fava bean protein concentrates, preferably, fava bean protein concentrates, that are treated to remove unwanted flavors. In this specification, such fava bean protein concentrates are called de-flavored fava bean protein concentrates. Fava bean protein concentrates are de-flavored using aqueous fluid, for example one or more of an aqueous steam, aqueous solution, or liquid water. Although similar processes are known and described, for example in WIPO publication WO 2016-120234, applicants have surprisingly found process conditions capable of obtaining highly functional (for example relatively highly soluble) de-flavored fava bean protein concentrates that have significantly less flavor than de-flavored legume protein concentrates currently on the market.

In one aspect the technology disclosed in this specification pertains to a de-flavored fava bean protein concentrate. In preferred embodiments this specification discloses a de-flavored fava bean protein concentrate. In any embodiment described in this specification a de-flavored fava bean protein concentrate is a powdered composition obtain from fava beans having protein content greater than the base fava bean. Commonly fava beans have protein content from about 20% to about 30% according de-flavored fava bean protein concentrates have protein content greater from about 30% to about 35%, or to about 40%, or to about 45%, or to about 45%, or to about 50% or to about 55%, or two about 60%, or to about 65%, or two about 70% or to about 75%. In other embodiment this specification describes a de-flavored fava bean protein concentrate having a fava bean protein content from about 50% to about 70% (wt. % of the concentrate) or to about 67% or to about 62%, or from about 53% to about 70%, or to about 67% or to about 62. In some preferred embodiments a fava bean protein concentrate has protein content from about 53% to about 57%. In another preferred embodiments a fava bean protein concentrate has protein content from about 57% to about 63%. In still another preferred embodiments a fava bean protein concentrate has protein content from about 63% to about 67%.

In any embodiment described in this specification, a de-flavored fava bean protein concentrate has a particle size distribution having a D50 from about 10 or from about 15 to about 35 microns, or from a range selected from the group consisting of from about 25, or from about 27 microns to about 35 or to about 33 or to about 31 microns; and from about 15 or from about 17 or from about 20 microns to about 25, or to about 23 microns.

In any embodiment described in this specification, a de-flavored fava bean protein concentrate has a particle size distribution having a D90 or from about 45 or from about 50 or from about 60, or from 70 or from 80, or from 90, or from about 100, or from about 115 or from about 120 microns to about 150, or to about 145, or to about 140, or to about 137 microns.

In any embodiment described in this specification, a de-flavored fava bean protein concentrate has a particle size distribution having D10 of from about 2 or from about 3 to about 7 or about 6 microns.

In any embodiment described in this specification, a de-flavored fava bean protein concentrate has a particle size distribution wherein the percent of particles that pass through a 100-mesh (149 micron) sieve is at least about 90% or at least about 95%.

In any embodiment described in this specification, a de-flavored fava bean protein concentrate has a percent soluble protein of from about 50% or from about 52% to about 60%, or to about 57%, or to about 55% (w/w).

Heat-moisture treated fava bean protein concentrates as described in this specification are further observed to have improved solubility compared to heat-moisture treated fava bean protein concentrates having lower denaturation enthalpy (are more denatured). In any embodiment described in this specification, a heat moisture treated fava bean protein concentrate has percent protein soluble in water of from about 60 to about 70%, or from about 60% to about 68% or from about 62% to about 68%.

In any embodiment described in this specification, a de-flavored fava bean protein concentrate has at least one reduced flavor compared to a base fava bean protein concentrate the reduced flavor being selected from the group consisting of bitter flavor, aftertaste; raw/green beany flavor, earthy/dirty flavor, savory flavors; metallic flavor.

In any embodiment described in this specification, a de-flavored fava bean protein concentrate is further observed to have a % reduction of certain volatile compounds associated with flavors or odors that occur in a base fava bean protein concentrate.

In any embodiment a de-flavored fava bean protein concentrate has at least 55% (measured using the GC/MS method provided in this specification) of at least one chemical present in a base fava bean protein concentrate wherein, optionally, the chemical present in the base fava bean protein concentrated is at least one of Hexanal, 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, 3-Methyl-Butanoic Acid, Benzenemethanol, Benzeneethanol, Eicosane, Nonadecane.

In any embodiment, a de-flavored fava bean protein concentrate has at a % reduction of at least 70% (measured using the GC/MS method provided in this specification) of at least one chemical present in a base fava bean protein concentrate wherein, optionally, the chemical present in the base fava bean protein concentrated is at least one of Hexanal, 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, Benzenemethanol, Benzeneethanol, Eicosane, Nonadecane.

In any embodiment, a de-flavored fava bean protein concentrate has at a % reduction of at least 75% (measured using the GC/MS method provided in this specification) of at least one chemical present in a base fava bean protein concentrate wherein, optionally, chemical present in the base fava bean protein concentrated is at least one of 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, 3-Methyl-Butanoic Acid, Benzenemethanol, Benzeneethanol, Eicosane, Nonadecane.

In any embodiment, a de-flavored fava bean protein concentrate has at a % reduction of at least 80% (measured using the GC/MS method provided in this specification) of at least one chemical present in a base fava bean protein concentrate wherein, optionally, chemical present in the untreated fava bean protein concentrated is at least one of 2-Penten-1-01, (Z)-, N Heptanal, 3-Methyl-1-Butanol, 1-Pentanol, Ethenyl-Benzene, 1-Hexanol, 3-Methyl-Butanoic Acid, Benzenemethanol, Benzeneethanol, Eicosane, Nonadecane.

In any embodiment, de-flavored fava bean protein concentrate has at a % reduction of at least 85% (measured using the GC/MS method provided in this specification) of at least one chemical present in a base fava bean protein concentrate wherein, optionally, chemical present in the base fava bean protein concentrated is at least one of 2-Penten-1-01, (Z)-, N Heptanal, 3-Methyl-1-Butanol, Ethenyl-Benzene, 1-Hexanol, 3-Methyl-Butanoic Acid, Benzenemethanol.

In any embodiment, a de-flavored fava bean protein concentrate has at a % reduction of at least 90% (measured using the GC/MS method provided in this specification) of at least one chemical present in a base fava bean protein concentrate wherein, optionally, chemical present in the base fava bean protein concentrated is at least one of 2-Penten-1-01, (Z)-, N Heptanal, Ethenyl-Benzene, 1-Hexanol, 3-Methyl-Butanoic Acid, Benzenemethanol.

In any embodiment described in this specification, a de-flavored fava bean protein concentrate is not enzymatically or chemically modified.

In another aspect, this specification discloses methods for making a de-flavored fava bean protein concentrate. In broadest terms the process applies an aqueous fluid to a base fava bean protein concentrate to obtain a moistened fava bean protein concentrate; heats the moistened fava bean protein concentrate to obtain to obtain a heat-treated fava bean protein concentrate; and mills the heat-treated fava bean protein concentrate to obtain a de-flavored fava bean protein concentrate having a defined particle size distribution. A complete process may also upstream steps from the from de-flavoring processor other intermediate steps between heating and milling to obtain the final product. The upstream processes include steps to obtain a base fava bean protein concentrate whether starting from whole fava bean, partial fava beans, or fava bean flour. Intermediate steps may include processes to further dry a heat-treated protein concentrate.

Starting from whole or partial fava beans, these are ground or milled to obtain a fava bean flour. In this specification fava bean flour refers to a powdered composition suitable for making a base fava bean flour that is obtained by grinding or milling a fava bean or any part of fava bean or other similar process. Within this specification fava bean flour includes compositions having particle sizes that may more commonly be thought of as fava bean meal or fava bean grits. Fava bean flour can be obtained by any suitable method such as grinding or milling, including wet milling, dry milling, and fava bean flour has substantially the same fava bean protein content as the fava bean.

A base fava bean protein concentrate has a protein content as described in this specification, which is a protein content higher than occurs in fava beans. To obtain the increase protein content, any process can be used to that will produce a base fava bean protein concentrate having the characteristics described in this specification. A useful method for classifying and separating components of a fava bean flour to obtain a base fava bean protein concentrate is air classification. Air classification uses air current as a countervailing force to separate parts of a fava bean flour. For example, an air classifier may use air currents and a rotating mechanism to generate a centripetal fore on the flour. In operation, starch and protein generally have different weight and size and so experience drag and centripetal differently force. These differences can be used separate the protein from other parts of the flour. Air classifiers are known and available for example from Hosokawa-Alpine. An air classification process obtains a high protein, low starch portion called in this specification the base fava bean protein concentrate. The classification process also produces a low protein, high starch portion which can be used for other purposes.

Following air classification of the fava bean flour to obtain a base fava bean protein concentrate, the base fava bean protein concentrate is heat-treated in a process that use heat and moisture to de-flavor the fava bean protein concentrate. Moisture is applied to the base fava bean protein concentrate as one or more of aqueous steam, liquid water or aqueous solution. This reaction increases moisture content of the base fava bean protein concentrate above its ambient moisture content, commonly from about 8% to about 12% (wt. % moisture content). The additions of one or more of aqueous steam, and liquid water or aqueous solution is not intended to create a slurry, meaning that preferably, for any embodiment disclosed in this specification, the protein concentrate is able to absorb all liquid added to the system so that the system remains a single-phase systems (i.e. there is only a protein concentrate phase; there is no free liquid phase). Generally, fava bean protein concentrate can have a moisture content of from about 50% to about 60% (wt. % moisture) before a liquid phase forms.

With regard to an apparatus suitable for de-flavoring a fava bean protein concentrate, de-flavored fava bean protein concentrates described in this specification can be made in one or more reactors useful for applying one or more of aqueous steam, liquid water or aqueous solution to form a mixture and heating the mixture. A useful reactor is a fluidizing bed reactor, an illustrative embodiment of which is described in U.S. Pat. No. 5,378,434. Fluidized bed reactors generally comprise a hollow reactor vessel with one or more ports, at least some being at the bottom of the vessel, through which air or other gas is pumped to disperse (fluidize) a powder placed within the chamber of the reactor. Among the gases that can be injected into a fluidizing bed reactor is steam. Fava bean protein concentrates can be moistened by injection of steam alone (the fava bean protein concentrate being loaded into the reactor at ambient moisture) or can be pre-moistened prior to being loaded into the reactor. With reference to the methods for de-flavoring fava bean protein concentrate described in this specification, air flow and steam flow in the reactor apply moisture to base fava bean protein concentrate. The reactor wall can be heated, and heated gas can be used to heat the moistened fava bean protein concentrates as described in this specification. Also, the moisture content of the gas in the fluidizing bed reactor can be adjusted to dry the de-flavored fava bean protein.

Another useful reactor is a hollow tube reactor hollow-tube type reactors useful for carrying out the methods for de-flavoring fava bean protein concentrate described in this specification include but are not limited to CoriMix® reactors (Lödige Process Technologies) and Horizontal Plow Mixers (B&P Littleford), and other reactors of this type. Generally a hollow-tube reactor comprises hollow-tube through which material may pass, inlet ports or other means for introducing solid materials like, base fava bean protein concentrate, and a fluids, like air or aqueous steam or liquid water or aqueous solution, into the hollow tube of the reactor so that the fluid is applied to the material passing through the reactor. Hollow-tube reactors also comprise a rotor, which is commonly screw shaped or comprises a radially projecting elements (like a fan). In operation the rotor pushes the material forward to an outlet port and may press material against the inner wall of the hollow tube as the material is pushed from an inlet port to an outlet port. In the methods for de-flavoring fava bean protein concentrate described in this specification the inner wall of the hollow tube is heated to the temperatures described in order to heat the moistened fava bean protein concentrate as it is pushed through the length of the hollow tube.

In at least some embodiments of the methods described in this specification, one or more of aqueous steam, and liquid water or aqueous solution are applied to the base fava bean protein concentrate to form a moistened fava bean protein concentrate that is heated in a first hollow-tube reactor to form a de-flavored fava bean protein concentrate that is dried in a second hollow-tube reactor. Steam and liquid are applied from different ports into the reactor but may be applied concurrently or sequentially in either order (steam or liquid) to obtain the moistened fava bean protein concentrate Also applying moisture and heating of the base fava bean protein concentrate can happen sequentially or concurrently, and in preferred embodiments are moistened and heated substantially concurrently by moistening a feed stock of base fava bean protein concentrated in a heated reactor.

Following heating, the heat-treated fava bean protein concentrate may be further dried using a fluid bed reactor or hollow tube reactor to a moisture content close to the equilibrium moisture of fava bean protein concentrate for example between about 4 and 15% (wt. %). Once dried to the desired moisture content the heat-treated fava bean protein concentrate is again milled to obtain a desired particle size. Second milling is useful to break-up aggregates of protein or protein and starch formed during the heat treatment. Also the second milling effects flavor intensive of the de-flavored fava bean protein concentrate. In preferred embodiments heat-treated fava bean protein concentrate is milled using an air classifying mill. This may of the type of apparatus used to air classify the fava bean flour, although it need not and more often will not be the same instance of the apparatus type-even of the same kind the fava bean flour and heat-treated fava bean protein concentrate will be air classified in different classifiers.

In at least some embodiments an air classifying mill, mills, classifies, and separates particles in the in the heat-treated fava bean protein concentrate—i.e. it will break down aggregates, and segregate aggregates of generally unwanted size from particles within a desired particle size distribution. Air classifying mills are available from Hosokawa-Alpine. Within an air classifying mill air classification occurs as described. Milling is done by some grinding apparatus through which a fluidized stream of heat-treated fava bean protein concentrate must pass. The grinding apparatus may a set of teeth on a rotating platform or other perforated solid structure that can break down aggregate particles within the fluidized stream as particles collide with solid structures. Once through the mill the fluidizing air stream pushes the particles to a separator which is a rotating structure having chambers to collect and carry particles of a desired size to an end repository. In practice particle size can be controlled for in an air classifying mill by varying one or more of the fluidizing air stream, the rotational speed of the mill and the rotation speed of a separator.

Description of specific operating parameters of reactors to make a de-flavored fava bean protein concentrate are disclosed. In any embodiment, this specification described a method for making a de-flavored fava bean protein concentrate comprising: applying an aqueous fluid to a fava bean protein concentrate to obtain a moistened fava bean protein concentrate; heating the moistened fava bean protein concentrate at a temperature from about 140° C., or from about 150° C., or from about 160° C., or from about 175° or to about 200° C., or to about 190° or two about 185° C. to obtain to obtain a heat-treated fava bean protein concentrate; and milling the heat-treated fava bean protein concentrate to obtain the de-flavored fava bean protein concentrate.

In any embodiment described in this specification, a method for making a de-flavored fava bean protein concentrate uses a classifying mill to separate at least a part of the heat-treated fava bean protein concentrate, wherein preferably the classifying mill is an air classifying mill.

In any embodiment described in this specification, a method for making a de-flavored fava bean protein concentrate uses a classifying mill that separates at least a part of the heat-treated fava bean protein concentrate to obtain the de-flavored fava bean protein concentrate wherein the obtained de-flavored fava bean protein concentrate has a particle size distribution having a D50 or from about 12, to about 35 microns, or from a range selected from the group consisting of from about 25, or from about 27 microns to about 35 or to about 33 or to about 31 microns; and or from 12, or from about 15 or from about 17 or from about 20 microns to about 25, or to about 23 microns.

In any embodiment described in this specification, a method for making a de-flavored fava bean protein concentrate uses an air classifying mill to separate at least part of the heat-treated fava bean protein concentrate by varying one or more of a fluidizing air speed, mill rotation speed, and separator rotation speed to obtain the de-flavored fava bean protein concentrate wherein the obtained de-flavored fava bean protein concentrate has a particle size distribution having a D50 or from about 12, or from about 15 to about 35 microns, or from a range selected from the group consisting of from about 25, or from about 27 microns to about 35 or to about 33 or to about 31 microns; and from about 12, or from about 15 or from about 17 or from about 20 microns to about 25, or to about 23 microns.

In any embodiment described in this specification, a method for making a de-flavored fava bean protein concentrate uses an air classifying mill capable of separating at least a part of the heat-treated fava bean protein concentrate using separator having variable rotational speed and separating at least a portion of the heat-treated fava bean protein concentrate using a rotational speed of from about 1000 or about 1050 or about 1100 or from about 1125 RPM to about 1200 RPM, or to about 1175 RPM.

In any embodiment described in this specification, a method for making a de-flavored fava bean protein concentrate uses an air classifying mill comprising one or more of a separator, to obtain the de-flavored fava bean protein concentrate wherein the de-flavored fava bean protein concentrate has a particle size distribution having a D50 from about 15 to about 35 microns, or from a range selected from the group consisting of from about 25, or from about 27 microns to about 35 or to about 33 or to about 31 microns; and from about 15 or from about 17 or from about 20 microns to about 25, or to about 23 microns.

In any embodiment described in this specification a de-flavored fava bean protein concentrate is made by applying moisture a base fava bean protein concentrate and heating moistened fava bean protein concentrate in a hollow tube reactor or a fluidized bed reactor.

In any embodiment described in this specification a de-flavored fava bean protein concentrate is made by heating a moistened fava bean protein concentrate a time from about 1 to 2 minutes to obtain the heat-treated fava bean protein concentrate.

In any embodiment described in this specification a de-flavored fava bean protein concentrate is made by the applying one or more of an aqueous steam, liquid water, or aqueous solution optionally, wherein, the applying step comprises applying aqueous steam and liquid water; optionally wherein the liquid water or aqueous solution, preferably liquid water, is applied to the fava bean protein concentrate in ratio (concentrate to water) of from about 4.0:1 to about 6.0:1, or to about 5.7:1 or to about 5.5:1 or to about 5.3:1, or to about 5.0:1, or to 4.7:1, or to about 4.5 to 1 or to about 4.3:1 and optionally, wherein, the aqueous steam is applied to the base fava bean protein concentrate in a ratio (concentrate to steam) of from about 10:1 or about 10.5:1 to about 12:1, or about 11.5:1.

In any embodiment described in this specification a de-flavored fava bean protein concentrate is made by drying the heat-treated fava bean protein concentrate to a moisture content from about 4% to about 15% (wt. %) with an air flow having a temperature from about 140° C. to about 160° C., or from about 145° C. to about 155° C.

In any embodiment described in this specification a de-flavored fava bean protein concentrate is made by applying moisture to a base fava bean protein concentrate and by heating a moisten fava bean protein concentrate in a hollow tube of a hollow tube reactor, the reactor further comprising a rotor within the hollow tube of the hollow-tube reactor; and wherein the rotor is rotated at a rate or from about 400, or from about 450, or from about 500 RPM, or from about 550, or about from about 600 or from about 650 or from about 700 or from about 750 to about 900 or to about 850, or from about 550 to about 900, or to about 850, or to about 800, or to about 750 or to about 700 or to about 650; preferably, wherein the rotor is rotated from about 500 to about 600 RPM or from about 550 to about 650 RPM, more preferably, wherein the rotor is rotated from about or less than about 700 to about 900 RPM or from about 750 to about 850 RPM.

In any embodiment described in this specification a de-flavored fava bean protein concentrate is made by drying the de-flavored fava bean protein concentrate in a hollow tube of a hollow-tube reactor, the reactor comprising a rotor within the hollow tube of the hollow-tube reactor; and wherein the rotor is rotated at a rate of from about 300 to about 500 RPM or from about 350 to about 450 RPM optionally, wherein, the de-flavored fava bean protein concentrate is dried to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 500 RPM or from about 350 to about 450 RPM.

In any embodiment described in this specification a de-flavored fava bean protein concentrate is made by applying moisture to a base fava bean protein concentrate and heating a moistened fava bean protein concentrate in a first hollow-tube reactor and drying a de-flavored fava bean protein concentrate in a second hollow-tube reactor.

In any embodiment described in this specification a de-flavored fava bean protein concentrate is made by separating at least part of a protein from a fava bean flour to obtain the base fava bean protein concentrate.

In any embodiment described in this specification a de-flavored fava bean protein concentrate is made by providing a fava bean flour comprising a fava bean protein and separating part of the fava bean protein from the base fava bean flour using a process that does not denature the protein in the flour.

In any embodiment described in this specification a de-flavored fava bean protein concentrate is made by providing a fava bean flour comprising a fava bean protein and separating part of the fava bean protein from the base fava bean flour using an air classifying process.

In any embodiment described in this specification a de-flavored fava bean protein concentrate the liquid water or aqueous solution or aqueous steam do not comprise an enzyme or chemical that that enzymatically or chemically modifies the de-flavored fava bean flour.

Also described are de-flavored fava bean protein concentrates made by any process described in this specification.

The de-flavored fava bean protein concentrates described are used as other protein concentrate and other fava bean protein concentrates are used. In any embodiment described in this specification, a de-flavored fava bean protein concentrate as is used food composition. The fava bean protein concentrates useful in food compositions in an amount from 1% to 99% wt. % of the food composition. The disclosed fava bean protein concentrates are useful to replace can be used to replace animal protein or replace gluten containing protein concentrates or to provide fortification relative cereal protein concentrates. Illustrative food compositions include gravies, sauces, particularly vegan white sauces or cheese sauces, soups, puddings, salad dressings, analog yogurts, analog sour creams, custards, analog cheese products, baked goods including pastries and dough based baked goods like pie crusts, cookies, breads, crackers, or batter based baked goods like cakes, and muffins.

In at least some embodiments a de-flavored fava bean protein concentrate, as described in this specification, is used in a baked good to reduce the usage of a cereal protein concentrate in whole or in part. In at least some embodiments of the de-flavored fava bean protein concentrate is used in a gluten free baked good.

The de-flavored fava bean protein concentrates have been observed, advantageously, to reduce the hardness of a baked good relative to the same baked good using a base fava bean protein concentrate.

In any embodiment this specification describes methods for making a food composition comprises adding a de-flavored fava bean protein concentrate and a second ingredient. With reference to compositions that are edible ingredients, second ingredients can be any edible ingredient, including but not limited to aqueous or lipid-based ingredients, fats, oils, other starches (including native, gelatinized, and modified starches), protein isolates or concentrates, protein concentrate, hydrocolloids or gelling agents, flavorings, coloring, sweeteners, and dairy ingredients.

With reference to specific certain food composition (particularly baked goods) the composition may comprising a wheat flour used in a ratio (de-flavored fava bean flour to wheat flour) of from about 1:1 to about 1:5, or from about 1:2 to about 1:5, or from 1:3, to 1:5. In any embodiment of a food composition described in this specification a baked good, has a flour component that consists of all the flour within the baked good, wherein the flour component comprises de-flavored fava bean flour in an amount of at least about 10%, or at least about 20%, or at least about 30%, or at least about 40%, or at least about 50%. Also, in any embodiment of a food composition described in this specification a baked good comprise a flour component that consists of all of the flour within the bake good, and wherein the flour component consists of de-flavored fava bean flour and wheat flour and wherein the de-flavored fava bean flour is used in the flour component in an amount from about 10% to about 50%, or to about 40%, or to about 30%, or to about 25% (wt. %), or from about 15% to about 50%, or to about 40%, or to about 30%, or to about 25% (wt. %).

De-flavored fava bean protein concentrates are useful in oil-in-water emulsions, where the de-flavored fava bean protein concentrate acts as an emulsifier. Emulsions may be savory or sweet and include ice creams, sauces, dressings, gravies. De-flavored fava bean protein concentrates may be used in an oil-in-water emulsion, having oil content of greater than about 25%, or greater than about 45%, or greater than about 70%, or from about 25%, to about 80%, or from about 25% to about 55%, or from about 55% to about 80%. In any embodiment of food composition described in this specification an oil-in-water emulsion comprises a de-flavored fava bean protein concentrate in an amount from about 0.1, or from about 0.25% or from about 0.45%, or from about 0.65% to about 5%, or to about 4%, or to about 3%, or to about 2%, or to about 1.75%, or to about 1.65%, or to about 1.55%, or to about 1.45% or to about 1.35%, or to about 1.25%, or to about 1.15%, or to about 1.05%.

The process disclosed in this specification to make de-flavored fava bean protein concentrates and the uses of de-flavored fava bean protein concentrates described in this specification are applicable to other.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting aspects, which are provided for illustrative purposes and are not intended to limit the full scope of the invention.

1. A de-flavored fava bean protein concentrate having a fava bean protein content selected from a range within the group consisting of from about 50% to about 70% (wt. % of the concentrate) or to about 67% or to about 62%, or from about 53% to about 70%, or to about 67% or to about 62% and having a percent protein soluble in water of from about 60 to about 70%, or from about 60% to about 68% or from about 62% to about 68%.

2. The de-flavored fava bean protein concentrate of claim 1 or 2 having at least one reduced flavor compared to a base fava bean protein concentrate the reduced flavor being selected from the group consisting of bitter flavor, aftertaste; raw/green beany flavor, earthy/dirty flavor, savory flavors; metallic flavor

3. The de-flavored fava bean protein concentrate of any one of claims 1 to 3 that is not enzymatically or chemically modified.

4. The de-flavored fava bean protein concentrate of any one of claims 1 to 4 having a % reduction of at least 55% (measured using the GC/MS method provided in this specification) of at least one chemical present in an untreated fava bean protein concentrate wherein, optionally, the chemical present in an untreated fava bean protein concentrated is at least one of Hexanal, 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, 3-Methyl-Butanoic Acid, Benzenemethanol, Benzeneethanol, Eicosane, Nonadecane.

5. The de-flavored fava bean protein concentrate of any one of claims 1 to 4 having a % reduction of at least 70% (measured using the GC/MS method provided in this specification) of at least one chemical present in an untreated fava bean protein concentrate wherein, optionally, the chemical present in an untreated fava bean protein concentrated is at least one of Hexanal, 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, Benzenemethanol, Benzeneethanol, Eicosane, Nonadecane.

6. The de-flavored fava bean protein concentrate of any one of claims 1 to 5 having a % reduction of at least 75% (measured using the GC/MS method provided in this specification) of at least one chemical present in an untreated fava bean protein concentrate wherein, optionally, chemical present in an untreated fava bean protein concentrated is at least one of 2-Penten-1-01, (Z)-, N Heptanal, 3-Methyl-1-Butanol, 2-Pentyl-Furan, 1-Pentanol, Ethenyl-Benzene, 1-Hexanol, Acetic Acid, 3-Methyl-Butanoic Acid, Benzenemethanol, Benzeneethanol, Eicosane, Nonadecane.

7. The de-flavored fava bean protein concentrate of any one of claims 1 to 6 having a % reduction of at least 80% (measured using the GC/MS method provided in this specification) of at least one chemical present in an untreated fava bean protein concentrate wherein, optionally, chemical present in an untreated fava bean protein concentrated is at least one of 2-Penten-1-01, (Z)-, N Heptanal, 3-Methyl-1-Butanol, 1-Pentanol, Ethenyl-Benzene, 1-Hexanol, 3-Methyl-Butanoic Acid, Benzenemethanol, Benzeneethanol, Eicosane, Nonadecane.

8. The de-flavored fava bean protein concentrate of any one of claims 1 to 7 having a % reduction of at least 85% (measured using the GC/MS method provided in this specification) of at least one chemical present in an untreated fava bean protein concentrate wherein, optionally, chemical present in an untreated fava bean protein concentrated is at least one of 2-Penten-1-01, (Z)-, N Heptanal, 3-Methyl-1-Butanol, Ethenyl-Benzene, 1-Hexanol, 3-Methyl-Butanoic Acid, Benzenemethanol.

9. The de-flavored fava bean protein concentrate of any one of claims 1 to 8 having a % reduction of at least 90% (measured using the GC/MS method provided in this specification) of at least one chemical present in an untreated fava bean protein concentrate wherein, optionally, chemical present in an untreated fava bean protein concentrated is at least one of 2-Penten-1-01, (Z)-, N Heptanal, Ethenyl-Benzene, 1-Hexanol, 3-Methyl-Butanoic Acid, Benzenemethanol.

10. A method for making a de-flavored fava bean protein concentrate comprising: a. in a reactor applying an aqueous fluid to a base fava bean protein concentrate to obtain a moistened fava bean protein concentrate; b. heating the moistened fava bean flour at a temperature from about 160° C. to about 200° C., or from about 170° C. to about 190° or from about 175° C. to about 185° C. to obtain to obtain a heat-treated fava bean protein concentrate; c. and optionally, milling the heat-treated fava bean protein concentrate to obtain the de-flavored fava bean protein concentrate; wherein, the aqueous fluid is at least an aqueous steam and wherein the aqueous steam is applied to the base fava bean protein concentrate in a ratio (concentrate to steam) greater than 7:1 to greater than 8:1 or greater than 9:1 or greater than 10:1, or from about 10:1 to about 12:1, or from about 10.5:1 to about 12:1, or from about 10:1 or about 11.5:1 or from about 10.5:1 to about 11.5:1 wherein, optionally the aqueous fluid further comprises a liquid water or aqueous solution, preferably liquid water, which is applied to the base fava bean protein concentrate in ratio (concentrate to water) of from about 4.0:1 to about 6.0:1, or from about 4.0:1 to about 5.7:1 or from about 4.0:1 to about 5.5:1 or from about 4.0:1 to about 5.3:1, or from about 4.0:1 to about 5.0:1, or from about 4.0:1 to 4.7:1, or from about 4.0:1 to about 4.5 to 1 or from about 4.0:1 to about 4.3:1.

11. The method of claim 10 wherein the milling uses a classifying mill to separate at least a part of the heat-treated fava bean protein concentrate, wherein preferably the classifying mill is an air classifying mill.

12. The method of any one of claim 10 or 11 wherein the milling uses a classifying mill that separates at least a part of the heat-treated fava bean protein concentrate to obtain the de-flavored fava bean protein concentrate wherein the obtained de-flavored fava bean protein concentrate has a particle size distribution having a D50 from about 10 to about 35 microns, or from about 15 to about 35, or from about 20 to about 35 or from about 25 to about 35, or from about 10 to about 25 or from about 10 to about 20, or from about 10 to about 15, or from a range selected from the group consisting of a. from about 25, or from about 27 microns to about 35 or to about 33 or to about 31 microns; and b. from about 10 or, or from about 12, or from about 15 or from about 17 or from about 20 microns to about 25, or to about 23 microns.

14. The method of any one of claims 10 to 12 wherein the milling uses an air classifying mill to separate at least part of the heat-treated fava bean protein concentrate by varying one or more of the air flow speed, rotor speed, and separator speed to obtain the de-flavored fava bean protein concentrate wherein the obtained de-flavored fava bean protein concentrate has a particle size distribution having a D50 from about 10 to about 35 microns, or from about 15 to about 35, or from about 20 to about 35 or from about 25 to about 35, or from about 10 to about 25, or from about 10 to about 20, or from about 10 to about 15, or from a range selected from the group consisting of a. from about 25, or from about 27 microns to about 35 or to about 33 or to about 31 microns; and b. from about 15 or from about 17 or from about 20 microns to about 25, or to about 23 microns.

15. The method of claims 10 to 13 wherein the milling uses an air classifying mill capable of separating at least a part of the heat-treated fava bean protein concentrate using separator having variable rotational speed and separating at least a portion of the heat-treated fava bean protein concentrate using a rotational speed of from about 1000, or about 1050, or about 1100, or from about 1125 RPM to about 1200 RPM, or from about 1000, or about 1050, or about 1100, or from about 1125 RPM to about 1175 RPM.

16. The method of any one of claims 10 to 14 wherein the milling uses an air classifying mill comprising a separator, to obtain the de-flavored fava bean protein concentrate wherein the de-flavored fava bean protein concentrate has a particle size distribution having a D50 from about 10 to about 35 microns, or from about 15 to about 35, or from about 20 to about 35 or from about 25 to about 35, or from about 10 to about 25, or from about 10 to about 20, or from about 10 to about 15, or from a range selected from the group consisting of a. from about 25, or from about 27 microns to about 35 or to about 33 or to about 31 microns; and b. from about 15 or from about 17 or from about 20 microns to about 25, or to about 23 microns.

17. The method of any one of claims 10 to 15 wherein the heating is for a time from about 1 to 2 minutes to obtain the heat-treated fava bean protein concentrate.

18. The method of any one of claims 10 to 17 further comprising drying the heat-treated fava bean protein concentrate to a moisture content from about 4% to about 15% (wt. %) with an air flow having a temperature from about 140° C. to about 160° C., or from about 145° C. to about 155° C.

19. The method of any one of claims 10 to 17 wherein the applying step and heating step occur in a hollow tube of a hollow tube reactor, the reactor further comprising a rotor within the hollow tube of the hollow-tube reactor; and wherein the rotor is rotated at a rate from about 400, or from about 450, or from about 500 RPM, or from about 550, or about from about 600 or from about 650 or from about 700 or from about 750 to about 900 or to about 850, or from about 550 to about 900, or to about 850, or to about 800, or to about 750 or to about 700 or to about 650; preferably, wherein the rotor is rotated from about 500 to about 600 RPM or from about 550 to about 650 RPM, more preferably, wherein the rotor is rotated from about or less than about 700 to about 900 RPM or from about 750 to about 850 RPM.

20. The method of any one of claims 10 to 18 further comprising drying the de-flavored fava bean protein concentrate in a hollow tube of a hollow-tube reactor, the reactor comprising a rotor within the hollow tube of the hollow-tube reactor; and wherein the rotor is rotated at a rate of from about 300 to about 500 RPM or from about 350 to about 450 RPM. optionally, wherein, the de-flavored fava bean protein concentrate is dried to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 500 RPM or from about 350 to about 450 RPM.

21. The method of any one of claims 10 to 19 wherein the applying step and heating step are done in a first hollow-tube reactor and the de-flavored fava bean protein concentrate is dried in a second hollow-tube reactor.

22. The method of any one of claims 10 to 20 further comprising, prior to step a) separating at least part of a protein from a base fava bean flour to obtain the base fava bean protein concentrate.

23. The method of any one of claims 10 to 21 further comprising, prior to step a) providing a base fava bean flour comprising a fava bean protein and separating part of the fava bean protein from the base fava bean flour using a process that does not denature the protein in the flour.

24. The method of any one of claims 10 to 22 further comprising, prior to step a) providing a base fava bean flour comprising a fava bean protein and separating part of the fava bean protein from the base fava bean flour using an air classifying process.

25. The method of any one of claims 10 to 24 wherein the liquid water or aqueous solution or aqueous steam do not comprise an enzyme or chemical that that enzymatically or chemically modifies the base fava bean protein concentrate.

26. A de-flavored fava bean protein concentrate as described in any one of claims 1 to 9 made according to a process a described in any one claims 10 to 24.

27. Use of a de-flavored fava bean protein concentrate as described in any foregoing claim a food composition.

28. Use of a de-flavored fava bean protein concentrate as described in claim 26 to replace at least part of a cereal flour in a baked good, optionally, wherein the de-flavored pulse protein concentrate replaces the cereal flour on a one-for-one basis (w/w).

29. Use of a de-flavored fava bean protein concentrate as described in claim 26 or 27 in a gluten free baked good.

30. Use of a de-flavored fava bean protein concentrate as described in any one of claims 26 to 29 in an oil-in-water emulsion, wherein the emulsion has an oil content of greater than about 25%, or greater than about 45%, or greater than about 70%, or from about 25%, to about 80%, or from about 25% to about 55%, or from about 55% to about 80%.

31. A food composition comprising a de-flavored fava bean protein concentrate as described in any foregoing claim and an edible ingredient.

32. The food composition of claim 30 wherein the composition is a food composition, or a gluten free food composition.

33. The food composition of claim 30 or 31 further comprising a wheat flour used in a ratio (de-flavored fava bean flour to wheat flour) of from about 1:1 to about 1:5, or from about 1:2 to about 1:5, or from 1:3, to 1:5.

34. The food composition of any one of claims 30 to 32 being a baked good, which has a flour component that consists of all the flour within the baked good, and wherein the flour component comprises de-flavored fava bean flour in an amount of at least about 10%, or at least about 20%, or at least about 30%, or at least about 40%, or at least about 50%.

35. The food composition of any one of claims 30 to 33 being a baked good comprising a flour component that consists of all of the flour within the bake good, and wherein the flour component consists of de-flavored fava bean flour and wheat flour and wherein the de-flavored fava bean flour is used in the flour component in an amount from about 10% to about 50%, or to about 40%, or to about 30%, or to about 25% (wt. %), or from about 15% to about 50%, or to about 40%, or to about 30%, or to about 25% (wt. %).

36. The food composition of any one of claims 30 to 23 being a gluten free.

37. The food composition of any one of claims 30 to 25 being an oil in water emulsion comprising: a. an oil content of greater than about 25%, or greater than about 45%, or greater than about 70%, or from about 25%, to about 80%, or from about 25% to about 55%, or from about 55% to about 80%; and b. de-flavored fava bean protein concentrate as described in any foregoing claim in an amount from about 0.1, or from about 0.25% or from about 0.45%, or from about 0.65% to about 5%, or to about 4%, or to about 3%, or to about 2%, or to about 1.75%, or to about 1.65%, or to about 1.55%, or to about 1.45% or to about 1.35%, or to about 1.25%, or to about 1.15%, or to about 1.05%. The technology described in this specification can be further understood with reference to the following non-limiting examples, which are provided for illustrative purposes and are not intended to limit the full scope of the invention.

### Example 1—Water Solubility of De-Flavored Fava Bean Protein Concentrates

For this example de-flavored fava bean protein concentrates were made in a hollow-tube reactor using the parameters said Table 1. Multiple batches were made to assess variance in the end-materials made use the same conditions.

TABLE 1
Parameters to Make De-flavored Fava Bean Protein Concentrate

| Feed | Cooker | Cooker | Water | Steam | Mill |
|---|---|---|---|---|---|
| Rate | Temp. | speed | Rate | Rate | Separator |
| (kg/hr) | (C.) | (%) | (L/hr) | (L/hr) | speed (rpm) |
| 3300 | 180 | 80% | 600 | 300 | 1400 |

Heat moisture treated fava bean protein concentrates were evaluated for percent solubility of protein. Percent protein solubility of a heat moisture treated fava bean protein concentrate was determined using a modified method of Morr et al. (J. Food Science 50 (1985) 1715-et seq.) and Karaca et al (Food Res. Int'l 44 (2011) pp. 2742-2750). Protein solutions were prepared by dispersing 1% w/v of protein in buffer with pH adjustment to 7 with either 0.1 M NaOH or 0.1 M HCl as needed. Following establishing desired pH, protein concentrate was mixed with solution (solution into protein) by vortexing for 30 sec for 1 hour followed by centrifuging at 4000×g for 10 min at room temperature. The nitrogen content of the supernatant was determined using LECO protein analyzer (LECO, TruMac® N). Percent protein solubility was calculated by dividing the nitrogen content of the supernatant by the total nitrogen in the sample (×100%).

Percent soluble protein of heat moisture treated fava bean protein concentrates is reported in Table 2.

TABLE 2
Water Solubility of Various Heat-Moisture
Treated Fava Bean Protein Concentrates

| Samples | % Soluble Protein (w/w) |
|---|---|
| 1 | 65.5 |
| 2 | 65.0 |
| 3 | 66.0 |
| 4 | 64.5 |
| 5 | 67.0 |
| 6 | 56.0 |

Batch 6 is a commercial available samples obtained from a third party vendor.

### Example 2—Effect of Heat Moisture Treatment on the Presence of Certain Volatile Compounds in Heat Moisture Treated Fava Bean Protein Concentrates

Effect of the de-flavoring process on the presence of certain volatile compounds associated causing flavor, aroma or both was evaluated using gas chromatography and mass spectroscopy (GC/MS). De-flavored fava bean protein concentrates were evaluated over various batch runs obtained using process conditions used to obtain samples 1 to 5 from Table 2. De-flavoring results are presented as the percent change in the area response for defined compounds detected using GC/MS. The percent change compared area response for compounds in untreated base pea protein concentrate (obtained using an air classification process) with heat-moisture treated pea protein concentrate. GS/MC process was done as follows.

Extraction of volatile flavor compounds from a sample containing pulse proteins was done using saturated sodium chloride solution and heat. A small amount of deuterated hexanal was added as an internal standard to a headspace vial containing the protein and saturated sodium chloride solution. The vial was incubated while a solid phase microextraction (SPME) fiber adsorbed the volatile compounds from the headspace (Divinylbenzene/Carboxen/Polydimethylsiloxane (DVB/CAR/PDMS) SPME fibers 1 cm (p/n 57298-U)). The fiber was then desorbed into a GC/MS where the eluted volatile compounds were searched against the NIST Mass Spectral Search Program and identities were verified against published NIST retention time indexes. Relative quantitation for each identified compound was then performed using mass spectrometry response versus the internal standard response. A DB-WAX UI (60 m×0.25 mm×0.25 μm) was applied as stationary phase with helium as the carrier gas.

Solutions/Indicators were prepared as follows. Saturated sodium chloride solution was made by placing 250 grams of sodium chloride in a 500 mL container. Fill the remaining container space with de-ionized Milli-Q water. Internal standard was made as follows. Transferred 10 μL of hexanal-d6 into 1 ml of methanol-d4 on the balance in a tared 1.5 mL screw cap vial.

Sample Preparation was a follows. Prepared in duplicate, 2.0 g of protein material or 4 mL of protein solution was weighed into a 20 mL headspace vial with SPME cap. 5 μL of internal standard was added. 4 mL of saturated sodium chloride solution is added to solid samples. If solids are slurries or high moisture approximately 1 g sodium chloride was added instead of the sodium chloride solution. The vial was capped and transfer to instrument tray.

Results are reported in Table 3. Results absolute values are reported in parts-per-million (PPM).

TABLE 3
Percent reduction in area response from
Gas Chromatography/Mass Spectroscopy
Between Heat Moisture Treated and Untreated
Fava Bean Protein Concentrates

| | | Average | Average | |
|---|---|---|---|---|
| | | Area | Area | |
| | | Response | Response | |
| | | (PPM) | (PPM) | |
| | | (Heat Moisture | (Untreated | |
| | | Treated Fava | Fava Bean | % |
| | | Bean Protein | Protein | Reduc- |
| CAS No. | Chemical Name | Concentrate) | Concentrate) | tion |
| 66-25-1 | Hexanal | 1.78 | 6.04 | 71 |
| 1576-95-0 | 2-Penten-1-Ol, (Z)- | 0.03 | 0.44 | 92 |
| 111-71-7 | N Heptanal | 0.03 | 0.48 | 94 |
| 123-51-3 | 1-Butanol, 3-Methyl- | 0.23 | 1.82 | 87 |
| 3777-69-3 | Furan, 2-Pentyl- | 0.16 | 0.67 | 76 |
| 71-41-0 | 1-Pentanol | 0.11 | 0.56 | 81 |
| 100-42-5 | Benzene, Ethenyl- | 0.05 | 1.76 | 97 |
| 111-27-3 | 1-Hexanol | 0.18 | 1.94 | 91 |
| 64-19-7 | Acetic Acid | 0.04 | 0.17 | 77 |
| 503-74-2 | Butanoic Acid, | 1.72 | 4.08 | 58 |
| | 3-Methyl- | | | |
| 100-51-6 | Benzenemethanol | 0.12 | 1.41 | 92 |
| 60-12-8 | Benzeneethanol | 0.10 | 0.62 | 84 |
| 112-95-8 | Eicosane | 0.04 | 0.23 | 83 |
| 629-92-5 | Nonadecane | 0.04 | 0.23 | 83 |

As shown, de-flavored fava bean protein concentrates have significantly reduced concentrations of many compounds associated with flavor and taste.

### Example 3—Sensory Evaluation of Pulse Protein Concentrate

Confirmation of improved flavor of de-flavored fava bean protein concentrate was obtained by taste testing samples blended with spring water to create 6.6% solutions, accounting for moisture of the samples. The de-flavored fava bean protein concentrate was obtained using process conditions like those used to obtain samples 1 to 5 from Table 2. All samples were evaluated by a highly trained external panel for 7 flavor and texture attributes. Samples (fava bean protein concentrate in water) were prepared on the day of evaluation and assessed at ambient temperature (about 21° C.). Intensities were rated using a 15-point Universal Scale. Analysis of Variance (ANOVA) and Tukey's post-hoc multiple comparison test was applied to the data to assess statistical significance. (See e.g. (See e.g. Meilgaard, M. C. et al., Sensory Evaluation Techniques, Fourth Edition, CRC Press (2007) (ISBN: 0-8493-3839-5) at pp. 189-254).

De-flavored fava protein concentrate trial samples had statistically significantly milder and cleaner flavor profiles than both the external commercial benchmark and untreated base material as reflected by their reduced intensities of overall flavor (driven by lower bitter taste and aftertaste; raw/green beany, earthy/dirty, and savory flavors; as well as the metallic sensation).

1. (canceled)

2. (canceled)

3. (canceled)

4. (canceled)

5. (canceled)

6. (canceled)

7. (canceled)

8. (canceled)

9. (canceled)

10. A method for making a de-flavored fava bean protein concentrate comprising:
a. in a reactor applying an aqueous fluid to a base fava bean protein concentrate to obtain a moistened fava bean protein concentrate;
b. heating the moistened fava bean flour at a temperature from about 160° C. to about 200° C.;
c. and optionally, milling the heat-treated fava bean protein concentrate to obtain the de-flavored fava bean protein concentrate;
wherein, the aqueous fluid is at least an aqueous steam and wherein the aqueous steam is applied to the base fava bean protein concentrate in a ratio (concentrate to steam) greater than 7:1 to about 12:1,

11. The method of claim 10 wherein the milling uses a classifying mill to separate at least a part of the heat-treated fava bean protein concentrate.

12. The method of claim 10 wherein the milling uses a classifying mill that separates at least a part of the heat-treated fava bean protein concentrate to obtain the de-flavored fava bean protein concentrate wherein the obtained de-flavored fava bean protein concentrate has a particle size distribution having a D50 from about 10 to about 35 microns.

13. The method of claim 10 wherein the milling uses an air classifying mill to separate at least part of the heat-treated fava bean protein concentrate by varying one or more of the air flow speed, rotor speed, and separator speed to obtain the de-flavored fava bean protein concentrate wherein the obtained de-flavored fava bean protein concentrate has a particle size distribution having a D50 from about 10 to about 35 microns.

14. The method of claim 10 wherein the milling uses an air classifying mill capable of separating at least a part of the heat-treated fava bean protein concentrate the separator having variable rotational speed and the classifying mill separates at least a portion of the heat-treated fava bean protein concentrate using a rotational speed of from about 1000 to about 1175 RPM.

15. The method of claim 10 wherein the milling uses an air classifying mill comprising a separator, to obtain the de-flavored fava bean protein concentrate wherein the de-flavored fava bean protein concentrate has a particle size distribution having a D50 from about 10 to about 35 microns.

16. The method of claim 10 wherein the heating is for a time from about 1 to 2 minutes to obtain the heat-treated fava bean protein concentrate.

17. The method of claim 10 further comprising drying the heat-treated fava bean protein concentrate to a moisture content from about 4% to about 15% (wt. %) with an air flow having a temperature from about 140° C. to about 160° C.

18. The method of claim 10 wherein the applying step and heating step occur in a hollow tube of a hollow tube reactor, the reactor further comprising a rotor within the hollow tube of the hollow-tube reactor; and
wherein the rotor is rotated at a rate from about 400 RPM to about 900 RPM;

19. The method of claim 10 further comprising drying the de-flavored fava bean protein concentrate in a hollow tube of a hollow-tube reactor, the reactor comprising a rotor within the hollow tube of the hollow-tube reactor; and wherein the rotor is rotated at a rate of from about 300 to about 500 RPM.

20. The method of claim 10 wherein the applying step and heating step are done in a first hollow-tube reactor and the de-flavored fava bean protein concentrate is dried in a second hollow-tube reactor.

21. The method of claim 10 further comprising, prior to step a) separating at least part of a protein from a base fava bean flour to obtain the base fava bean protein concentrate.

22. The method of claim 10 further comprising, prior to step a) providing a base fava bean flour comprising a fava bean protein and separating part of the fava bean protein from the base fava bean flour using a process that does not denature the protein in the flour.

23. The method of claim 10 further comprising, prior to step a) providing a base fava bean flour comprising a fava bean protein and separating part of the fava bean protein from the base fava bean flour using an air classifying process.

24. The method of claim 10 wherein the aqueous fluid does not comprise an enzyme or chemical that enzymatically or chemically modifies the base fava bean protein concentrate.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
